(19) United States
(12) Patent Application Publication
(10) Pub. No.: US 2020/0252842 A1
(43) Pub. Date: Aug. 6, 2020

(54) MANAGING CELL GROUP CONFIGURATION IN DISAGGREGATED BASE STATION ARCHITECTURE

(71) Applicant: GOOGLE LLC, Mountain View, CA (US)

(72) Inventors: Jing Hsieh, Taipei City (TW); Frank Wu, Taoyuan City (TW)

(21) Appl. No.: 16/782,937

(22) Filed: Feb. 5, 2020

Related U.S. Application Data
(60) Provisional application No. 62/801,540, filed on Feb. 5, 2019.

(51) Int. Cl. H04W 36/00; H04W 76/27; H04W 74/08; H04W 36/08; H04W 48/16; H04W 56/00

(52) U.S. Cl. CPC H04W 36/0055; H04W 76/27; H04W 56/0015; H04W 36/08; H04W 48/16; H04W 74/0833

(57) ABSTRACT

In a base station central unit (CU) coupled to one or more base station distributed units (DUs), a base station CU determines that a UE should perform a reconfiguration with sync procedure (1204). The base station CU transmits, to a base station DU, an indication that the UE should perform a reconfiguration with sync procedure (1204). The base station CU then receives, in response to the indication, a cell group configuration IE including a reconfiguration with synchronization IE (1208), and transmits, to the base station DU, a message including the cell group configuration IE, to be forwarded to the UE (1210).

### FIELD OF THE DISCLOSURE

This disclosure relates to wireless communications and, more particularly, to radio resource control procedures in disaggregated base station architecture.

### BACKGROUND

In a disaggregated base station, a base station central unit (CU) is coupled to one or more base stations distributed units (DUs). For example, a 5G radio access network (RAN) can include a next-generation Node B (gNB) made up of a gNB-CU coupled to one or more gNB-DUs via the F1 interface. Generally speaking, a gNB-CU is a logical node hosting Radio Resource Control (RRC), Service Data Adaptation Protocol (SDAP) and Packet Data Convergence Protocol (PDCP) protocols of the gNB; and a gNB-DU is a logical node hosting radio link control (RLC), medium access control (MAC) and physical (PHY) layers of the gNB. The gNB-CU partly controls operation of the gNB-DU. A user device (or user equipment (“UE”), as user devices are known in technical literature) communicates with a gNB-DU via a radio interface that conforms to 5G New Radio (NR), and the gNB-DU exchanges messages with the corresponding gNB-CU.

The gNB-CU in various scenarios can direct the UE to perform random access using Radio Resource Control (RRC) procedures such as RRC reconfiguration, or direct the UE to omit random access using an RRC resume procedure. The RRC connection resume procedure generally applies to the RRC_INACTIVE state, which the 5G protocol introduced to allow a UE to more quickly transition back to the RRC_CONNECTED state due to radio access network (RAN)-level base station coordination and RAN-paging procedures.

The gNB can configure the UE in the RRC_CONNECTED with a certain cell group configuration, which includes such information as RLC bearer configuration, MAC configuration (MAC-CellGroupConfig), physical layer configuration (PhysicalCellGroupConfig), special cell configuration (SpCellConfig), and secondary cell configuration (SCellConfig). The cell group configuration can include reconfiguration with synchronization (or sync), which includes serving cell configuration (ServingCellConfigCommon), a new UE identity (Radio Network Temporary Identifier (RNTI)), and timer T304 value configuration. The reconfiguration with sync in some cases includes dedicated random access channel (RACH) configuration (RACH-ConfigDedicated).

In some scenarios, a UE transmits to the gNB-DU a request to activate an RRC connection, e.g., RRCResumeRequest, RRCResumeRequest1, RRCSetupRequest, or RRCReestablishmentRequest. The gNB-DU transmits the request to the gNB-CU along with a cell group configuration. The gNB-DU includes also the ReconfigurationWithSync information element (IE) in the cell group configuration for the gNB-CU to convey reconfiguration with sync information. The gNB-CU then generates a response to the request to activate an RRC connection and includes the cell group configuration with the ReconfigurationWithSync in the response.

Upon receiving the ReconfigurationWithSync IE, the UE resets the MAC entity of the cell group. This causes the UE to consider the Time Alignment timer expired, which in turn causes the UE to consider the uplink unsynchronized. The UE accordingly fails to activate an RRC connection.

### SUMMARY

Generally speaking, the techniques of this disclosure prevent the gNB-DU from transmitting an RRC command that includes the ReconfigurationWithSync IE to the UE, under certain circumstances. The gNB-CU and/or the gNB-DU in various implementations thus cause the UE to not perform a reconfiguration with sync procedure and maintain (rather than reset) the MAC entity, and thereby retain link synchronization.

The gNB-CU in some implementations receives cell configuration information in the form of the cellGroupConfig IE from the gNB-DU, removes the ReconfigurationWithSync IE from the cellGroupConfig IE, and formats an RRC command for transmission to the UE via the gNB-DU with the modified cellGroupConfig IE. In these implementations, the gNB-CU formats the cellGroupConfig IE, and the gNB-DU then activates the radio connection while causing the UE to maintain the MAC entity by forwarding the RRC command to the UE via the radio interface.

In other implementation, the gNB-CU provides an indication to the gNB-DU that the gNB-DU should omit the ReconfigurationWithSync IE while formatting the cellGroupConfig IE. To this end, the gNB-CU in one example can use handover preparation information (e.g., where presence of the handover preparation information IE indicates that the gNB-DU should include the ReconfigurationWithSync IE, and absence of the handover preparation information IE indicates that the gNB-DU should omit the ReconfigurationWithSync IE). In another example implementation, the gNB-CU stores cell group configuration for the relevant cell group and provides a cellGroupConfig IE to the gNB-DU to indicate that the gNB-DU should include the ReconfigurationWithSync IE, and omits the cellGroupConfig IE from a message to the gNB-DU to indicate that the gNB-DU should omit the ReconfigurationWithSync IE).

One example embodiment of these techniques is a method in a base station CU coupled to one or more base station DUs. The method comprises receiving, by processing hardware from a base station DU, a cell group configuration information element (IE) including a reconfiguration with synchronization IE, related to a user equipment (UE). The method further includes determining, by the processing hardware, that the UE should not perform a reconfiguration with sync procedure; removing, by the processing hardware, the reconfiguration with synchronization IE from the cell group configuration IE to generate a modified cell group configuration IE; and transmitting, by the processing hardware to the base station DU, a message including the modified cell group configuration IE, to be forwarded to the UE.

Another example embodiment of these techniques is a method in a base station CU coupled to one or more base station DUs. The method includes determining, by processing hardware, that a UE should perform a reconfiguration with sync procedure; transmitting, by the processing hardware to a base station DU, an indication that the UE should perform a reconfiguration with sync procedure; receiving, by the processing hardware in response to the indication, a cell group configuration IE including a reconfiguration with synchronization IE; and transmitting, by the processing hardware to the base station DU, a message including the cell group configuration IE, to be forwarded to the UE.

Another embodiment of these techniques is a base station CU comprising processing hardware configured to implement the method above.

Yet another example embodiment of these techniques is a method in a base station DU coupled to a base station CU. The method comprises receiving, by processing hardware from a base station CU, an indication that a UE should perform a reconfiguration with sync procedure; generating, by the processing hardware, a cell group configuration IE that includes a reconfiguration with synchronization IE, for the UE; transmitting, by the processing hardware to the base station CU, the cell group configuration IE; receiving, by the processing hardware from the base station CU, a message for the UE including the cell group configuration IE; and transmitting, by the processing hardware to the UE, the message.

Still another embodiment of these techniques is a base station CU comprising processing hardware configured to implement the method above.

Another embodiment of these techniques is a disaggregated base station comprising a central unit (CU) and at least one distributed unit (DU) communicatively coupled to the base station DU. The disaggregated base station includes processing hardware configured to: (i) receive, via a radio interface from a user equipment (UE), an RRC message, determine that the UE should not perform a reconfiguration with sync procedure, and transmit an RRC command responsive to the RRC message, the RRC command including a cell group configuration IE and including a reconfiguration with synchronization IE.

### BRIEF DESCRIPTION OF THE DRAWINGS

FIG. 1 is a block diagram of an example wireless communication network in which a disaggregated base station manages cell group configuration in accordance with the techniques of this disclosure.

FIGS. 2-7 are messaging diagrams of several example scenarios according to which the devices of FIG. 1 can operate, in particular:

FIG. 2 illustrates a scenario in which a gNB-CU removes a reconfiguration with sync indication from the cell group configuration information element, which a gNB-DU transmits in response to a request to setup UE context;

FIG. 3 illustrates a scenario in which a gNB-CU removes a reconfiguration with sync indication from the cell group configuration information element, which a gNB-DU transmits in an initial uplink RRC message;

FIG. 4 illustrates a scenario in which a gNB-CU uses handover preparation information to provide, to a gNB-DU, an implicit indication that the gNB-DU should not include a reconfiguration with sync in a CellGroupConfig IE provided to a UE during an RRC resume procedure;

FIG. 5 illustrates a scenario in which a gNB-CU uses handover preparation information to provide, to a gNB-DU, an implicit indication that the gNB-DU should not include a reconfiguration with sync in a CellGroupConfig IE provided to a UE during an RRC connection establishment procedure;

FIG. 6 illustrates a scenario in which a gNB-CU uses a cell group configuration IE to provide, to a gNB-DU, an implicit indication that the gNB-DU should not include a reconfiguration with sync in a CellGroupConfig IE provided to a UE during an RRC resume procedure; and

FIG. 7 illustrates a dual-connectivity (DC) scenario in which a gNB-CU transmits, to the gNB-DU, an implicit indication of whether the gNB-DU should not include a reconfiguration with sync in the CellGroupConfig IE, and where the gNB-CU receives this indication from a master node.

FIG. 8 is a flow diagram of an example method for generating an RRC message with a modified cell group configuration, which can be implemented in the gNB-CU of FIG. 1.

FIG. 9 is a flow diagram of another example method for generating an RRC message with a modified cell group configuration, which can be implemented in the gNB-CU of FIG. 1.

FIG. 10 is a flow diagram of an example method for generating an implicit indication that the gNB-DU should not include reconfiguration with sync in a CellGroupConfig IE provided to a UE, which can be implemented in the gNB-CU of FIG. 1.

FIG. 11 is a flow diagram of another example method for generating an implicit indication that the gNB-DU should not include reconfiguration with sync in a CellGroupConfig IE provided to a UE, which can be implemented in the gNB-CU of FIG. 1.

FIG. 12 is a flow diagram of an example method for causing a UE to not perform a reconfiguration with sync procedure, which can be implemented in a CU unit of a base station.

FIG. 13 is a flow diagram of an example method for causing a UE to not perform a reconfiguration with sync procedure, which can be implemented in a DU unit of a base station.

FIG. 14 is a flow diagram of another example method for causing a UE to not perform a reconfiguration with sync procedure, which can be implemented in a CU unit of a base station.

### DETAILED DESCRIPTION OF THE DRAWINGS

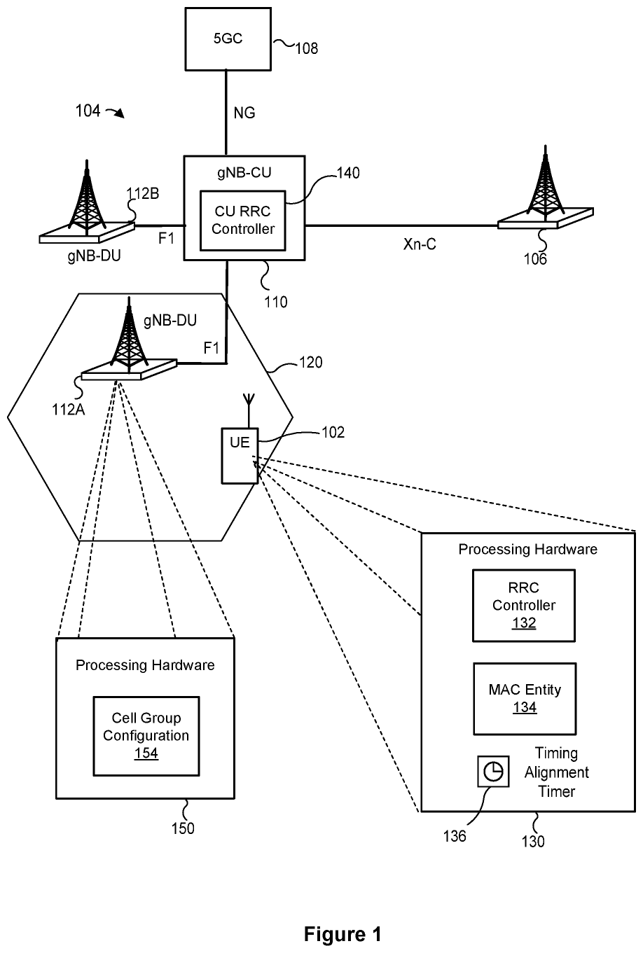

FIG. 1 depicts an example wireless communication network 100 in which a disaggregated gNB 104 manages RRC cell group configuration so as to allow a UE 102 to avoid resetting the MAC entity under certain conditions, in accordance with the techniques discussed below. The examples below refer primarily to gNBs that can communicate with UEs over the 5G NR radio access technology (RAT). However, these techniques more generally can apply to any suitable disaggregated base station architecture.

The disaggregated gNB 104 includes gNB-CU 110 and gNB-DUs 112A and 112B. In general, the gNB-CU 110 can be coupled to one, two, or more than two gNB-DUs. The gNB-CU 110 is coupled to the gNB-CU 110 via an F1 interface. The gNB-CU 110 also can be coupled to another base station 106, which can be disaggregated or non-disaggregated, via an Xn-C. The base station 106 can operate as a gNB or an eNB, and in some cases can operate as a master node (MN). In general, the wireless communication network 100 can include any number of base stations, and each of the base stations can cover one, two, three, or any other suitable number of cells. Further, the gNB-CU 110 is connected to a core network (CN) 108 of CN type 5GC. The gNB-DU 112A in this example configuration covers a 5G NR cell 120.

The UE 102 can be any suitable device capable of wireless communications (as further discussed below). The UE 102 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes an RRC controller 132, and the memory of the processing hardware stores a MAC entity 134 (e.g., as a data structure). The processing hardware 130 also can implement a Timing Alignment timer 136.

The gNB-CU 110 also can include processing hardware such as one or more CPUs and a non-transitory computer-readable memory. The processing hardware of the gNB-CU 110 can implement a CU RRC controller 140 that controls RRC procedures. Processing hardware 150 of the gNB-DU 112A also can include one or more general-purpose processors, a non-transitory computer-readable memory, special-purpose processing units, etc. The processing hardware in an example implementation includes a cell group configuration module 154.

In operation, the UE 102 connects to the gNB-CU 110 via the gNB-DU 112A. The gNB-DU 112 generates a certain cell group configuration for the UE 102. The gNB-DU 112 also provides the cell group configuration of the UE 102 to the gNB-CU 110, in the format of a CellGroupConfig IE. As discussed in more detail below, the gNB-DU 112 in some cases includes a ReconfigurationWithSync IE in the CellGroupConfig IE. When the gNB-CU 140 includes the ReconfigurationWithSync IE in an RRC command (such as RRCResume) and transmits the RRC command to the UE 102 via the gNB-DU 112A, the UE 102 performs one or more actions associated with the reconfiguration with sync procedure, which resets the MAC entity 134. As a result, the UE 102 considers the Timing Alignment timer 136 expires and determines that the uplink to the gNB-DU 112A is not synchronized. The UE 102 accordingly does not transmit the RRCResumeComplete command to the gNB-DU 112A.

To prevent the UE 102 from performing a reconfiguration with sync procedure (which causes the resetting of the MAC entity 134), the CU RRC controller 140 determines in some cases that the gNB-CU 110 and/or gNB-DU 112A should not include the ReconfigurationWithSync IE in the message to the UE 102. In the various implementations discussed above, the CU RRC controller 140 provides an indication regarding omission of the ReconfigurationWithSync IE to the gNB-DU 112A. Several example scenarios in which the CU RRC controller 140 provides such an indication are discussed next.

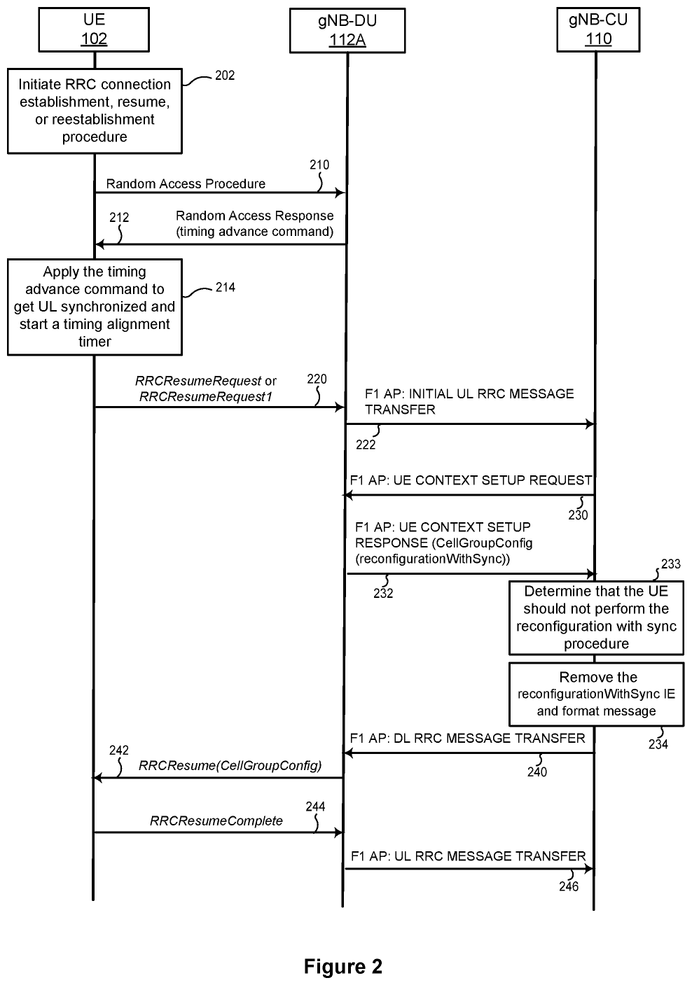

In the scenario of FIG. 2, the UE 102 initiates 202 an RRC connection establishment, resume, or a reestablishment procedure. The UE 102 performs 210 a random access procedure with the gNB-DU 112A and receives 212 a random access response including a timing advance command. The UE 102 then applies 214 the timing advance command to get the uplink synchronized and stats a timing alignment timer.

The UE 102 then transmits 220 an RRCResumeRequest or RRCResumeRequest1 message to the gNB-DU 112A, which forwards 222 the RRCResumeRequest or RRCResumeRequest1 message and, when needed, the corresponding low-layer configuration for the UE 102, to the gNB-CU 110 in the F1 Application Protocol (F1AP) INITIAL UL RRC MESSAGE TRANSFER message. To identify the UE 102, the message can include the C-RNTI the gNB-DU 112A allocated to the UE 102.

The gNB-CU 110 transmits 230 an F1AP UE CONTEXT SETUP REQUEST message to establish the UE context in the gNB-DU 112A. In some cases, this message also encapsulates an RRC SECURITY MODE COMMAND message. The gNB-DU 112A responds 232 with a F1AP UE CONTEXT SETUP RESPONSE message containing a cellGroupConfig IE.

In some implementations, the gNB-DU 112A includes in the F1AP UE CONTEXT SETUP RESPONSE message an indication of whether the CellGroupConfig IE contains a ReconfigurationWithSync IE. In one implementation, the F1AP UE CONTEXT SETUP RESPONSE message includes a binary indicator with a first value indicating that the ReconfigurationWithSync IE is present, and another value indicating that the ReconfigurationWithSync IE is absent. In another implementation, the F1AP UE CONTEXT SETUP RESPONSE message includes an optional flag, and presence of the optional flag indicates that the ReconfigurationWithSync IE is present. In still another implementation, presence of the optional flag indicates that the ReconfigurationWithSync IE is absent.

The gNB-CU 110 (e.g., the CU RRC controller 140) determines 233 that the UE 102 should not perform a reconfiguration with sync procedure. The gNB-CU 110 removes 234 the ReconfigurationWithSync IE from the cellGroupConfig IE, when present. The gNB-CU 110 then formats or encodes an RRCResume message to respond to the RRCResumeRequest or RRCResumeRequest1 message, and includes the cellGroupConfig IE that does not include an ReconfigurationWithSync IE in the message. The gNB-CU 110 then forwards 240 the RRCResume message to the gNB-DU 112A in an FLAP DL RRC MESSAGE TRANSFER message.

The gNB-DU 112 transmits 242 the RRCResume message to the UE 102 via the radio interface. Because the RRCResume message does not contain an ReconfigurationWithSync IE, the UE 102 does not reset the MAC entity 134 and does not consider uplink synchronization lost. The UE 102 accordingly responds 244 to the gNB-DU 112A with an RRCResumeComplete message. The gNB-DU 112A forwards 246 the RRCResumeComplete message to the gNB-CU 110 in an F1AP UL RRC MESSAGE TRANSFER message.

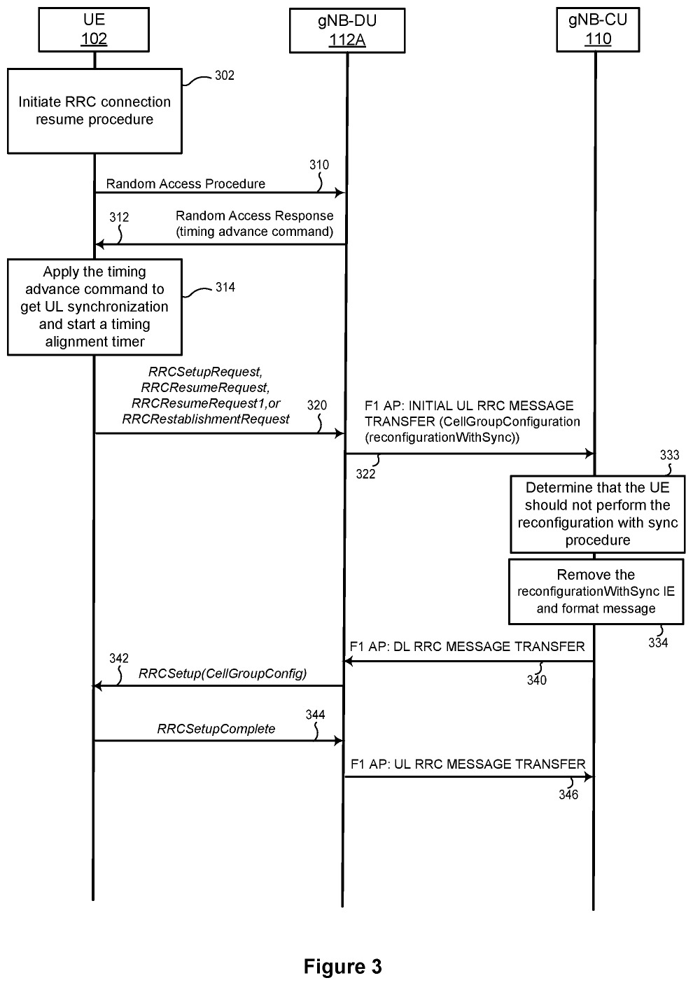

FIG. 3 illustrates another scenario in which the gNB-CU 110 removes the ReconfigurationWithSync IE from the CellGroupConfig IE. The UE 102 first initiates 302 an RRC resume procedure. Similar to the scenario of FIG. 2, the UE 102 performs 310 a random access procedure with the gNB-DU 112A, receives 312 a random access response including a timing advance command, and UE applies 314 the timing advance command.

The UE 102 transmits 320 an RRCSetupRequest, RRCResumeReequest, RRCResumeReequest1, or RRCReestablishmentRequest message to the gNB-DU 112A, which forwards 322 this message to the gNB-CU 110 in F1AP INITIAL UL RRC MESSAGE to the gNB-CU 110. In some implementations, the gNB-DU 112A includes in the F1AP INITIAL UL RRC MESSAGE message an indication of whether the CellGroupConfig IE contains a ReconfigurationWithSync IE.

The gNB-CU 110 then determines 333 that the UE 102 should not perform a reconfiguration with sync and removes 334 the ReconfigurationWithSync IE from the cellGroupConfig IE, when present. The gNB-CU 110 forwards 340 the RRCResume message to the gNB-DU 112A in an F1AP DL RRC MESSAGE TRANSFER message, the gNB-DU 112A transmits 342 the RRCSetup message without an ReconfigurationWithSync IE to the UE 102 via the radio interface, and the UE 102 resumes the RRC connection without resetting the MAC entity. The UE 102 responds 344 to the gNB-DU 112A with an RRCSetupComplete message, which the gNB-DU 112A forwards 346 to the gNB-CU 110 in an F1AP UL RRC MESSAGE TRANSFER message.

Referring generally to FIGS. 2 and 3, the gNB-CU 110 in some cases can decide to perform a UE Context Modification procedure and utilize similar techniques to prevent the UE 102 from resetting the MAC entity. More particularly, upon detecting an SpCell change, PSCell addition, SI update for PSCell and security key change, the gNB-CU 110 can determine that the UE 102 should perform a reconfiguration with sync procedure and transmit an RRC Reconfiguration message including the ReconfigurationWithSync IE to the UE 102 via the gNB-DU 112A. In other cases, the gNB-CU 110 can determine that the UE 102 should not perform a reconfiguration with sync procedure and transmit an RRC Reconfiguration message that does not include the ReconfigurationWithSync IE to the UE 102 via the gNB-DU 112A.

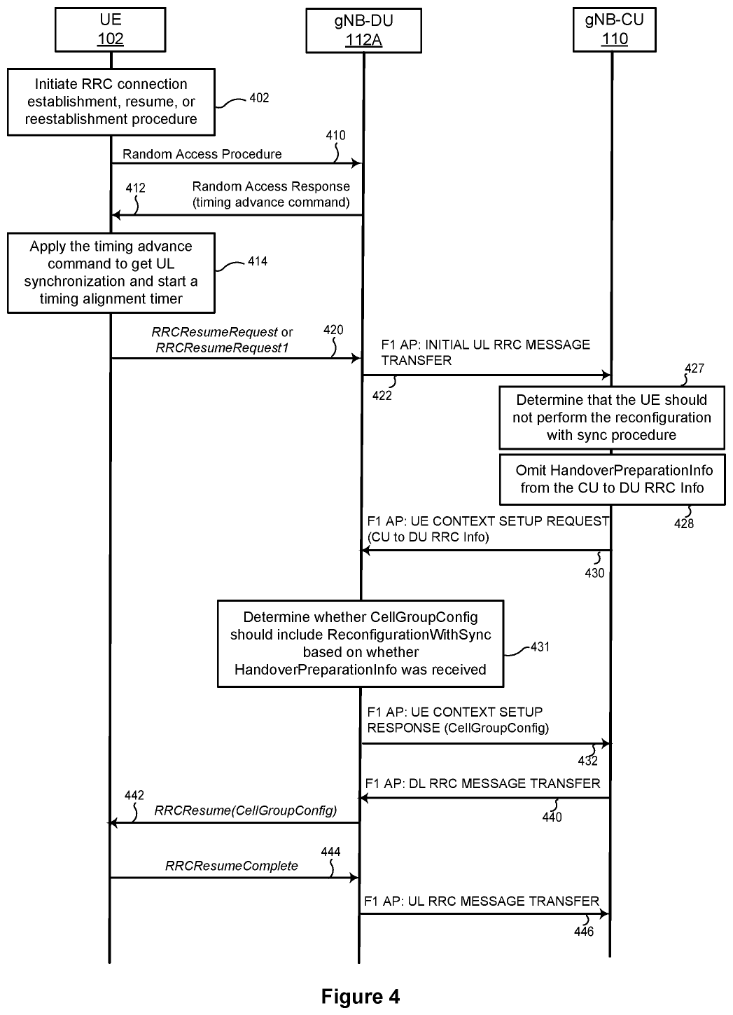

Next, FIG. 4 illustrates a scenario in which gNB-CU 110 provides to the gNB-DU 112A an implicit indication that the gNB-112A should not cause the UE 102 to perform a reconfiguration with sync procedure and reset the MAC entity. The UE 102 in this scenario initiates 402 an RRC connection establishment, resume, or a reestablishment procedure. The UE 102 performs 410 a random access procedure with the gNB-DU 112A and receives 412 a random access response including a timing advance command. The UE 102 then applies 414 the timing advance command to get the uplink synchronized, starts a timing alignment timer, and transmits 220 an RRCResumeRequest or RRCResumeRequest1 message to the gNB-DU 112A, and in response the gNB-DU 112A forwards 422 this message to the gNB-CU 110 in an INITIAL UL RRC MESSAGE TRANSFER message.

The gNB-CU 110 determines 427 that the UE 102 should nor perform a reconfiguration with sync procedure and determines 428 to not include the HandoverPreparationInfo in the CU to DU RRC Information IE. Presence or absence of HandoverPreparationInfo in this case operates as an implicit indication of whether the gNB-DU 112A should include or not include the ReconfigurationWithSync IE in the CellGroupConfig IE for the UE 102.

The gNB-CU 110 transmits 430 an F1AP UE CONTEXT SETUP REQUEST message with the CU to DU RRC Information IE to the gNB-DU 112A. The gNB-DU 112A then determines 431 whether the CU to DU RRC Information IE includes HandoverPreparationInfo. When the CU to DU RRC Information IE includes HandoverPreparationInfo, the gNB-DU 112A generates a cellGroupConfig IE that includes the ReconfigurationWithSync IE; otherwise, when the CU to DU RRC Information IE does not include HandoverPreparationInfo, the gNB-DU 112A generates a cellGroupConfig IE that does not include the ReconfigurationWithSync IE.

The gNB-DU 112A transmits 432 an F1AP UE CONTEXT SETUP RESPONSE message containing a cellGroupConfig IE. Then, similar to the scenario of FIG. 2, for example, the gNB-CU 110 forwards 440 the RRCResume message to the gNB-DU 112A in an F1AP DL RRC MESSAGE TRANSFER message, the gNB-DU 112 transmits 442 the RRCResume message to the UE 102 via the radio interface, the UE 102 responds 444 to the gNB-DU 112A with an RRCResumeComplete message (when the cellGroupConfig IE does not include the ReconfigurationWithSync IE), and the gNB-DU 112A forwards 446 the RRCResumeComplete message to the gNB-CU 110 in an F1AP UL RRC MESSAGE TRANSFER message.

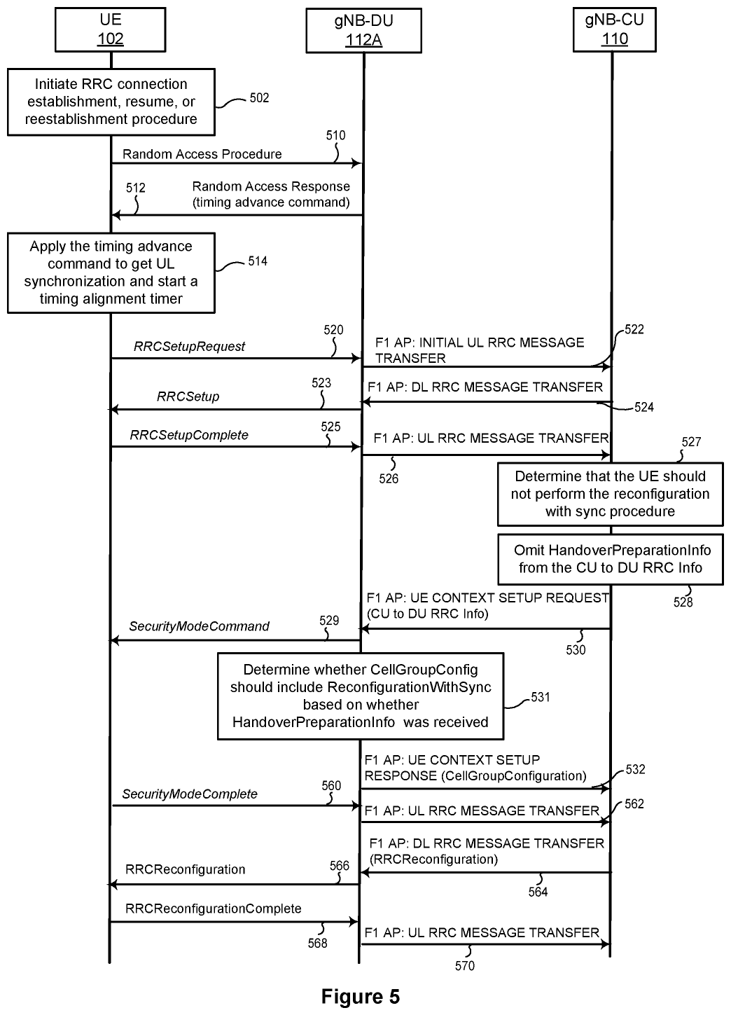

FIG. 5 illustrates a scenario in which a gNB-CU uses handover preparation information to provide, to a gNB-DU, an implicit indication that the gNB-DU should not include a reconfiguration with sync in a CellGroupConfig IE for a UE during an RRC connection establishment procedure. The UE 102 in this initiates 502 an RRC connection establishment procedure. The UE 102 performs 510 a random access procedure with the gNB-DU 112A, receives 512 a random access response including a timing advance command, and applies 514 the timing advance command to get the uplink synchronized and starts a timing alignment timer.

The UE 102 transmits 520 an RRCSetupRequest message to the gNB-DU 112A, which then forwards 522 this message to the gNB-CU 110 in F1AP INITIAL UL RRC MESSAGE to the gNB-CU 110. The gNB-CU 110 transmits 522 an F1AP DL RRC MESSAGE TRANSFER message enclosing an RRCSetup command to the gNB-DU 112A. The gNB-DU 112A forwards 523 the RRCSetup command to the UE 102, the UE 102 responds 525 with an RRCSetupComplete message, and the gNB-DU 112A forwards 526 the RRCSetupComplete message to the gNB-CU 110 in an F1AP RRC MESSAGE TRANSFER message.

The gNB-CU 110 determines 527 that the determines that the UE 102 should not perform a reconfiguration with sync procedure and determines 528 to not include the HandoverPreparationInfo in the CU to DU RRC Information IE. Similar to the scenario of FIG. 4, presence or absence of HandoverPreparationInfo in this case operates as an implicit indication of whether the gNB-DU 112A should include or not include the ReconfigurationWithSync IE in the CellGroupConfig IE for the UE 102.

The gNB-CU 110 transmits 530 an F1AP UE CONTEXT SETUP REQUEST message with the CU to DU RRC Information IE to the gNB-DU 112A. The F1AP UE CONTEXT SETUP REQUEST message in this case also includes a SecurityModeCommand. The gNB-DU 112A forwards 529 the SecurityModeCommand message to the UE 102. The gNB-DU 112A then determines 531 whether the CU to DU RRC Information IE includes HandoverPreparationInfo. When the CU to DU RRC Information IE includes HandoverPreparationInfo, the gNB-DU 112A generates a cellGroupConfig IE that includes the ReconfigurationWithSync IE; otherwise, when the CU to DU RRC Information IE does not include HandoverPreparationInfo, the gNB-DU 112A generates a cellGroupConfig IE that does not include the ReconfigurationWithSync IE. The gNB-DU 112A transmits 532 an F1AP UE CONTEXT SETUP RESPONSE message containing a cellGroupConfig IE.

After the UE 102 responds 560 to SecurityModeCommand with a SecurityModeComplete message, and the gNB-DU 112A forwards 562 this message to the gNB-CU 110 in a UL RRC MESSAGE TRANSFER message. As further illustrated in FIG. 5, the gNB-CU 110 subsequently transmits to the gNB-112A a DL RRC MESSAGE TRANSFER message enclosing an RRCReconfiguration message. The gNB-DU 112A forwards 566 this message to the UE 102 and receives 566 RRCReconfigurationComplete in response. The gNB-DU 112A forwards 570 the RRCReconfigurationComplete message to the gNB-CU 110 in an UL RRC MESSAGE TRANSFER message.

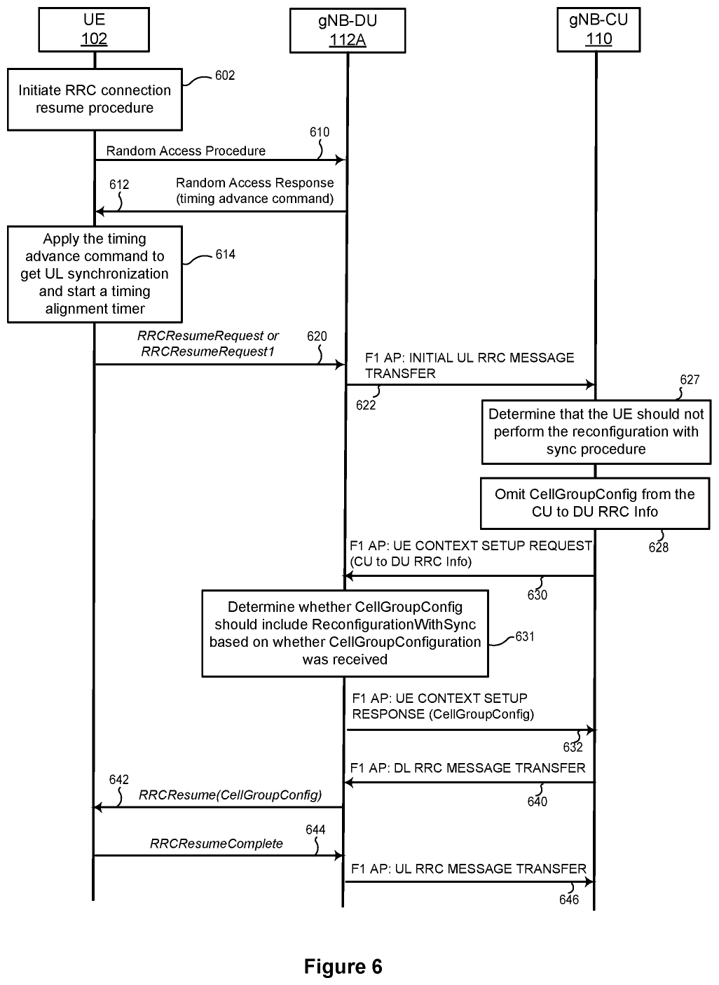

The scenario of FIG. 6 is similar to the scenario of FIG. 4, except that here the gNB-CU 110 uses the cellGroupConfig IE to indicate whether the gNB-DU 112A should provide the ReconfigurationWithSync IE to the UE 102, thereby causing the UE 102 to reset the MAC entity.

The events 602, 610, 612, 614, 620, and 622 are similar to the events 402, 610, 612, 614, 620, and 622, respectively. The gNB-CU 110 determines 627 the UE 102 should not perform a reconfiguration with sync procedure. According to this implementation, the gNB-CU 110 indicates to the gNB-112A that the UE 102 should not perform a reconfiguration with sync procedure by not including 628 the CellGroupConfig IE in the CU to DU RRC Information IE. The gNB-CU 110 the transmits 630 an F1AP UE CONTEXT SETUP REQUEST message with the CU to DU RRC Information IE to the gNB-DU 112A.

The gNB-DU 112A accordingly determines 631 whether the CU to DU RRC Information IE includes the CellConfigInfo IE. When the CU to DU RRC Information IE includes the CellConfigInfo IE, the gNB-DU 112A generates a cellGroupConfig IE that includes the ReconfigurationWithSync IE for the subsequent F1AP UE CONTEXT SETUP RESPONSE message; otherwise, when the CU to DU RRC Information IE does not include, the CellConfigInfo IE, the gNB-DU 112A generates a cellGroupConfig IE that does not include the ReconfigurationWithSync IE in the subsequent F1AP UE CONTEXT SETUP RESPONSE message. The remaining events 632, 640, 642, 644, and 646 in this scenario are similar to the events 432, 440, 442, and 446, respectively.

Thus, the gNB-CU 110 in some implementations can format the CellGroupConfig 1E in a manner that does not require the gNB-DU 112A to reformat this IE, as discussed with reference to FIGS. 2 and 3. As one alternative, the gNB-CU 110 can implicitly indicate to the gNB-DU 112A that the gNB-DU 112A should cause the UE 102 to not perform a reconfiguration with sync procedure by including or not including a certain IE such as HandoverPreparationInfo or CellGroupConfig, as discussed with reference to FIGS. 4-6. More generally, the gNB-CU 110 can provide this implicit indication using any IE whose presence or absence is related to whether the UE 102 should reset its MAC entity. Further, the gNB-CU 110 in some implementations can include an explicit indicator or flag in the F1AP message transmitted to the gNB-DU 112A, so that one value of the flag indicates that the gNB-DU 112A should include the ReconfigurationWithSync IE in the cellGroupConfig IE, and another value of the flag indicates that the gNB-DU 112A should not include the ReconfigurationWithSync IE in the cellGroupConfig IE (or presence of the flag indicates that the gNB-DU 112A should include the ReconfigurationWithSync IE in the cellGroupConfig IE, and absence of the flag indicates that the gNB-DU 112A should not include the ReconfigurationWithSync IE from the cellGroupConfig IE).

As further demonstrated in the discussion above, a disaggregated base station, such as the gNB 104, can generate the cellGroupConfig IE in the format provided to the UE 102 at a CU or a DU, depending on the implementation.

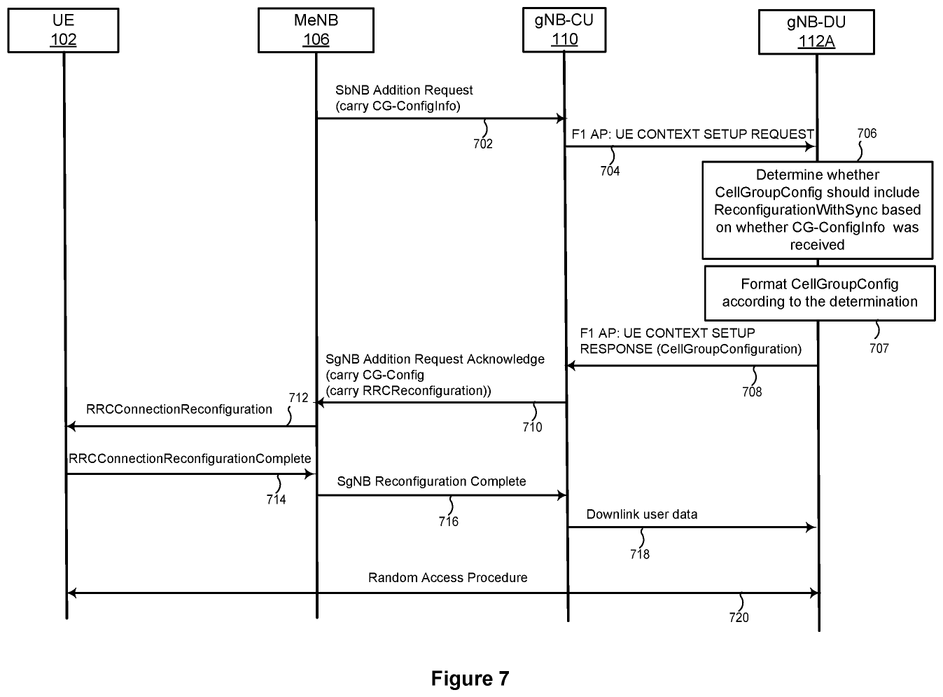

Next, FIG. 7 illustrates a scenario in which the gNB-CU 110 supports non-standalone operation, i.e., dual connectivity in addition to standalone operation. The base station 106 in this case operates as a Master eNB (MeNB). The MeNB 106 transmits 702, to the gNB-CU 110, an SgNB Addition Request message that includes a CG-ConfigInfo IE. The gNB-CU 110 transmits 704 an F1AP UE CONTEXT SETUP REQUEST message to the gNB-DU 112A and includes the CG-ConfigInfo in this message. The gNB-DU 112A then determines 706 whether the cellGroupConfig IE should include the ReconfigurationWithSync IE based on whether the F1AP UE CONTEXT SETUP REQUEST message includes the CG-ConfigInfo IE. For example, when the F1AP UE CONTEXT SETUP REQUEST message includes the CG-ConfigInfo IE, the gNB-DU 112A can include the ReconfigurationWithSync IE in the cellGroupConfig IE; otherwise, when the F1AP UE CONTEXT SETUP REQUEST message does not include the CG-ConfigInfo IE, the gNB-DU 112A does not include the ReconfigurationWithSync IE in the cellGroupConfig IE.

The gNB-DU 112A transmits 708 a F1AP UE CONTEXT SETUP RESPONSE message containing a cellGroupConfig IE to the gNB-CU 110, which then transmits 710 an SgNB Addition Request Acknowledge message that includes a CG-Config message, which in turn includes an RRCConnectionReconfiguration message. The MeNB 106 transmits 712 the RRCReconfiguration via the radio interface of the MN, and the UE 102 responds 714 with RRCConnectionReconfigurationComplete. The MeNB 106 transmits 716 an SgNB Reconfiguration Complete message to the gNB-CU 110. Subsequently to these steps, the gNB-CU transmits 718 downlink user data to the gNB-DU 112A, and the UE 102 can perform 720 a random access procedure to utilize the radio resources of the gNB-DU 112A in addition to those of the MeNB 106.

Referring generally to the messaging diagrams above, in at least some of the implementations, the gNB-CU 110 initiates the UE Context Setup procedure for handover if at least one DRB is set up for the UE 102, when the gNB-CU 110 operates as a MN. Similarly, the gNB-CU 110 can initiate the UE Context Setup procedure for handover if at least one DRB is set up for the UE 102, when the gNB-CU 110 operates as a MN.

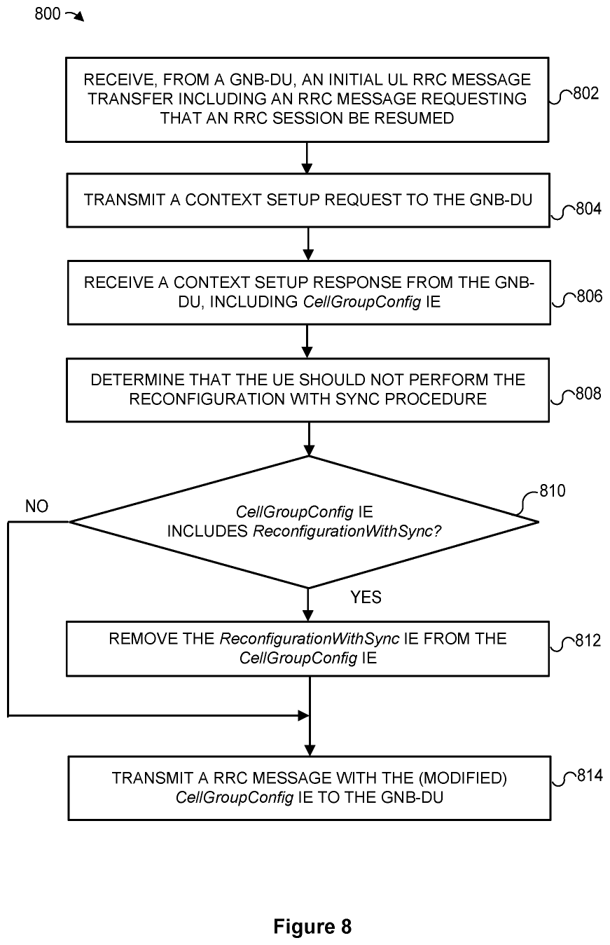

Next, several example methods that can be implemented in the gNB-CU 110 and/or gNB-DU 112A are discussed with reference to FIGS. 8-13.

Referring first to FIG. 8, an example method 800 for generating an RRC message with a modified cell group configuration can be implemented in a CU such as the gNB-CU 110 of FIG. 1. The method 800 can be implemented using any suitable combination of software, hardware, and/or firmware.

At block 802, the gNB-CU receives, from the gNB-DU (e.g., the gNB-DU 112A), an INITIAL UL RRC MESSAGE TRANSFER message that conveys an RRC message received from a UE (e.g., the UE 102). The RRC message can indicate a request that the RRC message be resumed, e.g., RRCResumeRequest or RRCResumeRequest1. Next, at block 804, the gNB-CU transmits a request to establish a UE context in the gNB-DU. The gNB-CU receives a response to this request at block 806.

The response includes a CellGroupConfig IE or, more generally, information conveying cell group configuration. The gNB-CU determines at block 808 that the UE should not perform a reconfiguration with sync procedure. The gNB-CU accordingly determines that the RRCResume message responsive to the RRC message received at block 802 should not contain the ReconfigurationWithSync IE (or, more generally, a reconfiguration with synchronization indication which causes the UE to reset its MAC entity).

At block 810, the gNB-CU determines whether the IE conveying cell group configuration received at block 806 includes the ReconfigurationWithSync IE and, if so, removes this IE at block 812. Otherwise, the flow proceeds directly to block 814, where the gNB-CU transmits an RRC message (e.g., RRCResume) with the CellGroupConfig IE to the gNB-DU, to be forwarded to the UE.

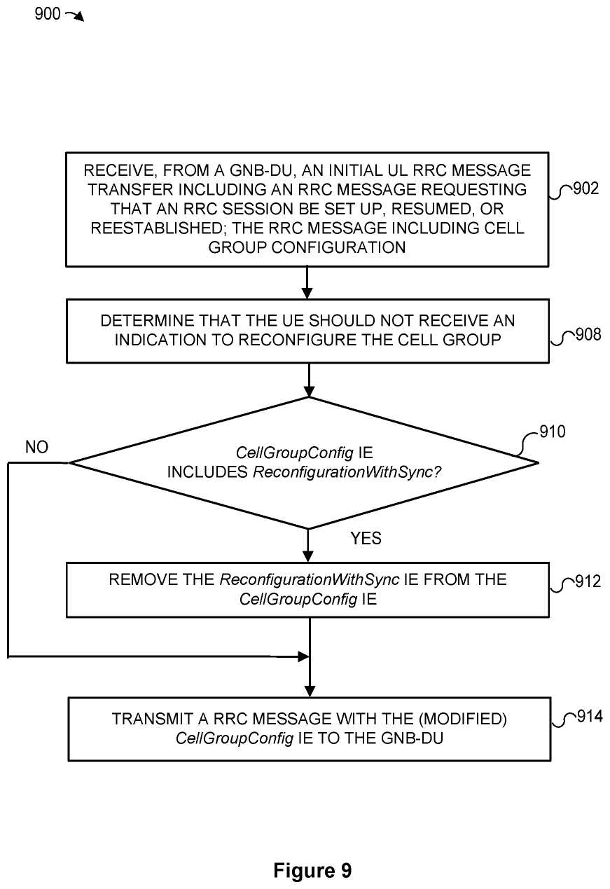

FIG. 9 illustrates another example method for generating an RRC message with a modified cell group configuration, which also can be implemented in the gNB-CU 110 or another suitable CU. The method 900 begins at block 902, where the gNB-CU receives, from the gNB-DU, an INITIAL UL RRC MESSAGE TRANSFER message that conveys an RRC message such as RRCSetupRequest, RRCResumeReequest, RRCResumeReequest1, or RRCReestablishmentRequest. Unlike the example of FIG. 8, the INITIAL UL RRC MESSAGE TRANSFER message includes the CellGroupConfig IE, which in some cases includes the ReconfigurationWithSync IE.

Similar to block 808 of FIG. 8, the gNB-CU determines at block 908 that the UE should not perform a reconfiguration with sync procedure, which resets its MAC entity. The gNB-CU then determines at block 910 whether the CellGroupConfig IE received from the gNB-DU includes the ReconfigurationWithSync IE and, if so, removes the ReconfigurationWithSync IE from the CellGroupConfig IE at block 912. Otherwise, the flow proceeds directly to block 914, where the gNB-CU transmits an RRC message (e.g., RRCSetup) with the CellGroupConfig IE to the gNB-DU, to be forwarded to the UE.

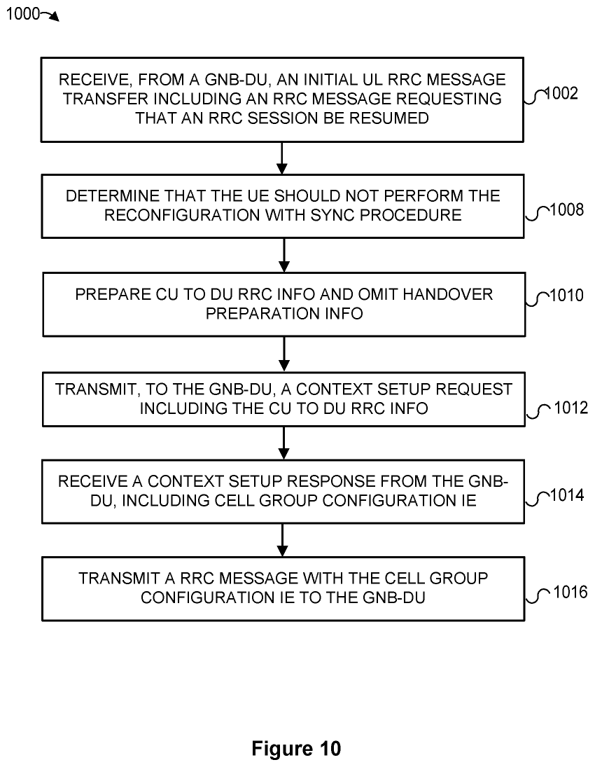

FIG. 10 illustrates an example method 1000 for generating an implicit indication that the gNB-DU should not include the ReconfigurationWithSync IE in an RRC message to a UE, which can be implemented in the gNB-CU 110. At 1002, the gNB-CU receives an INITIAL UL RRC MESSAGE TRANSFER message, similar to block 902. The gNB-CU determines that the UE should not perform a reconfiguration with sync procedure, which resets its MAC entity, at block 1008 and prepares a CU to DU RRC Info IE at block 1010. The gNB-CU does not include HandoverPreparationInfo in the CU to DU RRC Info IE to indicate to the gNB-DU that the UE should not perform a reconfiguration with sync procedure, which resets its MAC entity. The gNB-CU then transmits an FLAP UE CONTEXT SETUP REQUEST message including the CU to DU RRC Info IE to the gNB-DU at block 1012, and receives an F1AP UE CONTEXT SETUP RESPONSE message in response at block 1014. The received message includes a cellGroupConfig IE that does not include the ReconfigurationWithSync IE. The gNB-CU then formats and transmits an RRC Message including the cellGroupConfig IE to the gNB-DU, for transmission to the UE, at block 1016.

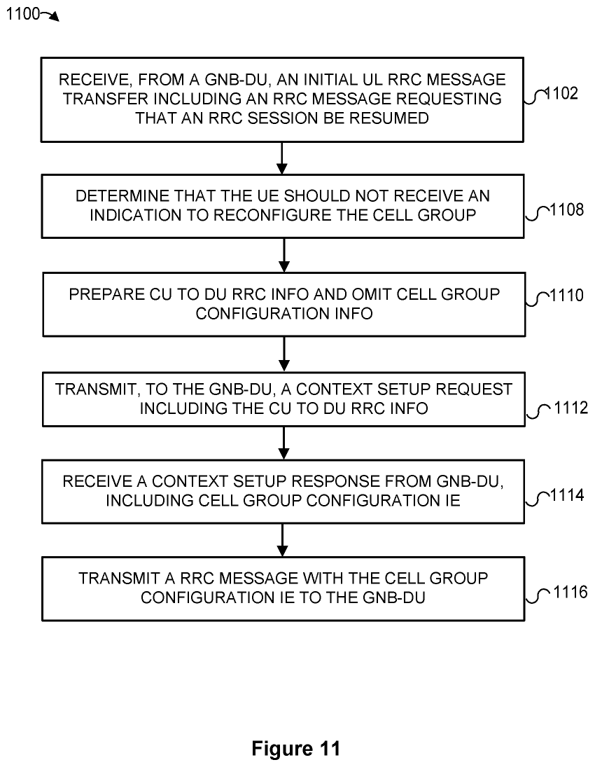

FIG. 11 is a flow diagram of another example method for generating an implicit indication that the gNB-DU should omit the ReconfigurationWithSync IE from an RRC message to a UE, which can be implemented in the gNB-CU 110. Block 1102-1116 are similar to blocks 1002-1016, but at block 1100 the gNB-CU uses inclusion or exclusion of the cellGroupConfig IE to implicitly indicate to the gNB-DU whether the RRC message to the UE should include the ReconfigurationWithSync IE.

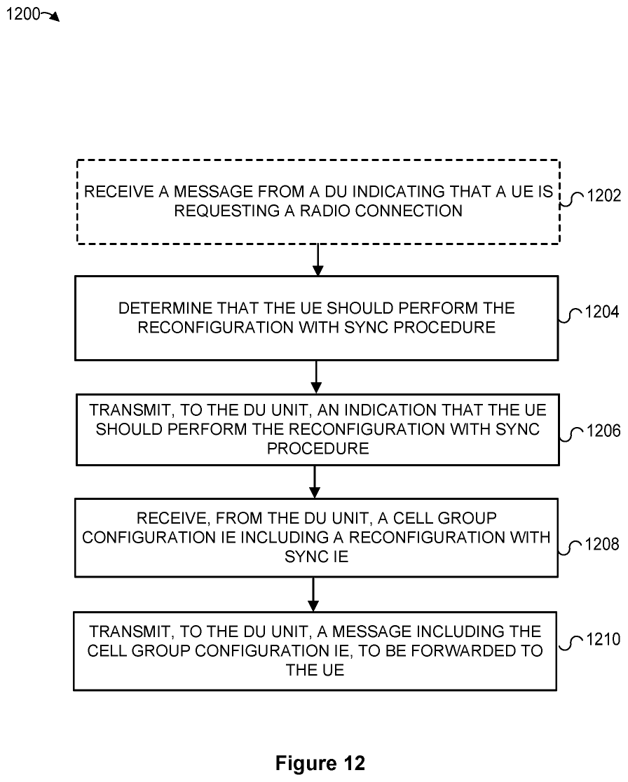

Next, FIG. 12 illustrates an example method for causing a UE to not perform a reconfiguration with sync procedure, which can be implemented in a CU unit of a base station, e.g., the gNB-CU 110.

At (optional) block 1202, the CU receives a message from the DU (e.g., an RRC message) indicating that a UE is requesting a radio connection (e.g., event 222 of FIG. 2, event 322 of FIG. 3, event 422 of FIG. 4, event 522 of FIG. 5, event 622 of FIG. 6, or event 702 of FIG. 7; see also block 802 of FIG. 8, block 902 of FIG. 9, block 1002 of FIG. 10, or block 1102 of FIG. 11).

At block 1204, the CU determines that the UE should not perform a reconfiguration with sync procedure, in connection with the procedure (e.g., the RRC procedure) the CU will perform with the UE (e.g., event 233 of FIG. 2, event 333 of FIG. 3, event 427 of FIG. 4, event 527 of FIG. 5, event 627 of FIG. 6, event 706 of FIG. 7; see also block 808 of FIG. 8, block 908 of FIG. 9, block 1008 of FIG. 10, or block 1108 of FIG. 11).

At block 1206, the CU transmits the corresponding indication, in an implicit manner (e.g., events 428 and 430 of FIG. 4, events 528 and 530 of FIG. 5, events 628 and 630 of FIG. 6, event 704 of FIG. 7; see also blocks 1010 and 1012 of FIG. 10, blocks 1110 and 1112 of FIG. 11).

Next, at block 1208, the CU receive a cell group configuration IE including the reconfiguration with sync IE from the DU (e.g., event 432 of FIG. 4, event 532 in FIG. 5, event 632 in FIG. 6, event 708 of FIG. 7; see also block 1014 of FIG. 10, block 1114 of FIG. 11).

At block 1210, the CU transmits a message (e.g., an RRC message responsive to the message received from the UE via the DU) to the DU, to be forwarded to the UE (e.g., event 440 of FIG. 4, event 570 of FIG. 5, event 640 of FIG. 6, event 710 of FIG. 7; see also block 814 of FIG. 8, block 914 of FIG. 9, block 1016 of FIG. 10, block 1106 of FIG. 11). The message includes the cell group configuration IE received at block 1208.

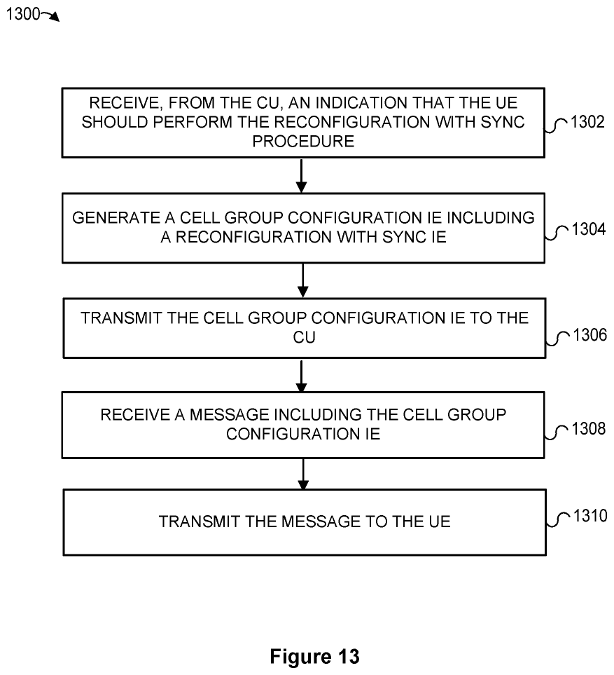

FIG. 13 illustrates an example method for causing a UE to perform reconfiguration with sync, which can be implemented in a DU unit of a base station, e.g., the gNB-DU 112A.

At block 1302, the DU receives an indication that the UE should perform the reconfiguration with sync, from the CU (generally similar to the events 428 and 430 of FIG. 4, events 528 and 530 of FIG. 5, events 628 and 630 of FIG. 6, event 704 of FIG. 7; see also blocks 1010 and 1012 of FIG. 10, blocks 1110 and 1112 of FIG. 11).

In some implementations, prior to executing block 1302, the DU generates and transmits to the CU an Initial UL RRC Message Transfer message including the cell group configuration IE. The DU does not include a reconfiguration with synchronization indication IE in the cell group configuration IE.

At block 1304, the DU generates a cell group configuration IE including the reconfiguration with sync IE (event 431 of FIG. 4, event 531 of FIG. 5, event 631 of FIG. 6, events 706 and 707 of FIG. 7). The DU transmits the cell group configuration IE including to the CU at block 1306 (event 432 of FIG. 4, event 532 of FIG. 5, event 632 of FIG. 6, event 708 of FIG. 7).

The DU at block 1308 receives a message including the cell group configuration IE (event 240 of FIG. 2, event 340 of FIG. 3, event 440 of FIG. 4, event 654 of FIG. 5, event 640) and, at block 1310, transmits this message to the UE (e.g., event 242 of FIG. 2, event 342 of FIG. 3, event 442 of FIG. 4, event 566 of FIG. 5, event 642 of FIG. 6).

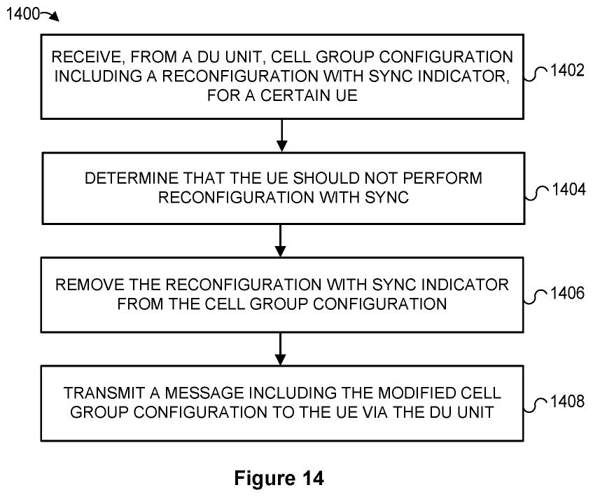

Finally, FIG. 14 illustrates another example method for causing a UE to not perform a reconfiguration with sync procedure, which can be implemented in a CU unit of a base station, e.g., the gNB-CU 110. According to this method, the CU (rather than the DU) formats the information element that determines whether the UE performs reconfiguration with sync.

The method 1400 begins at block 1402, where the CU receives cell group configuration with a reconfiguration with sync indicator, from a DU unit (event 232 of FIG. 2, event 322 of FIG. 3; see also block 806 of FIG. 8, block 902 of FIG. 9).

At block 1404, the CU determines that the UE should not perform reconfiguration with sync (event 233 of FIG. 2, event 333 of FIG. 3; see also block 808 of FIG. 8, block 908 of FIG. 9).

The CU at block 1406 removes the reconfiguration with sync indicator (when present) from the cell group configuration received from the DU (event 234 of FIG. 2, event 334 of FIG. 4; see also block 812 of FIG. 8, block 912 of FIG. 9).

At block 1408, the CU transmits a message including the modified cell group configuration to the UE via the DU unit (event 240 of FIG. 2, event 340 of FIG. 3; see also block 814 of FIG. 8, block 914 of FIG. 9).

Referring generally to FIGS. 12-14, in some cases the CU formats the final version of the cellGroupConfig IE for transmission to the UE (e.g., events 240 and 242 of FIG. 2, events 340 and 342 of FIG. 3, event 706 of FIG. 7), and in other cases the DU formats the cellGroupConfig IE for transmission to the UE, and the CU does not perform any further modification (e.g., event 431 of FIG. 4, event 531 of FIG. 5, event 631 of FIG. 6).

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for support packet-based voice and video calls through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

The following list of aspects reflects a variety of the embodiments explicitly contemplated by the present disclosure.

Aspect 1. A method in a base station CU coupled to one or more base station DUs (DUs) comprises: receiving, by processing hardware from a base station DU, a cell group configuration IE including a reconfiguration with synchronization IE, related to a UE; determining, by the processing hardware, that the UE should not perform a reconfiguration with sync procedure; removing, by the processing hardware, the reconfiguration with synchronization IE from the cell group configuration IE to generate a modified cell group configuration IE; and transmitting, by the processing hardware to the base station DU, a message including the modified cell group configuration IE, to be forwarded to the UE.

Aspect 2. The method of aspect 1, wherein receiving the cell group configuration IE from the base station DU includes: receiving, by the processing hardware from the base station DU, an Initial UL radio resource control (RRC) Message Transfer message; transmitting, by the processing hardware to the base station DU, a UE Context Setup Request message; and receiving, by the processing hardware from the base station DU, a UE Context Setup Response message including the cell group configuration IE.

Aspect 3. The method of aspect 1, wherein receiving the cell group configuration IE from the base station DU includes receiving, by the processing hardware from the base station DU, an Initial UL RRC Message Transfer message including the cell group configuration IE.

Aspect 4. The method of aspect 1, further comprising: receiving, by the processing hardware from the base station DU, an RRC request for one of (i) setting up a new RRC connection, (ii) resuming an RRC connection, or (iii) reestablishing an RRC connection, transmitted by the UE; wherein transmitting the message includes generating an RRC command responsive to the request from the UE.

Aspect 5. The method of aspect 1, wherein receiving the cell group configuration IE, the removing and transmitting the modified cell group configuration IE occur in a first instance, the method further comprising, in a second instance: determining, by the processing hardware, that the cell group configuration IE was received during a UE context modification procedure in response to one of (i) a special cell (SpCell) change, (ii) a primary secondary cell (PSCell) change, or (iii) a system information (SI) change for the PSCell, and including the cell group configuration IE in an RRC command, including not modifying the cell group configuration IE.

Aspect 6. The method of aspect 1, further comprising: receiving, by the processing hardware from the base station DU, a reconfiguration with sync presence indicator indicating that the cell group configuration IE includes the reconfiguration with synchronization IE.

Aspect 7. The method of aspect 1, further comprising: receiving, by the processing hardware from the base station DU, a reconfiguration with sync absence indicator indicating that the cell group configuration IE does not include the reconfiguration with synchronization IE.

Aspect 8. The method of aspect 6 or 7, further comprising: receiving the reconfiguration with sync presence indicator or the reconfiguration with sync absence indicator in one of an Initial UL RRC Message Transfer message or an UE Context Setup Response message.

Aspect 9. A method in a base station CU coupled to one or more base station DUs comprises: determining, by processing hardware, that a UE should perform a reconfiguration with sync procedure; transmitting, by the processing hardware to a base station DU, an indication that the UE should perform a reconfiguration with sync procedure; receiving, by the processing hardware in response to the indication, a cell group configuration IE including a reconfiguration with synchronization IE; and ransmitting, by the processing hardware to the base station DU, a message including the cell group configuration IE, to be forwarded to the UE.

Aspect 10. The method of aspect 9, wherein transmitting the indication to the base station DU includes: transmitting, by the processing hardware to the base station DU, a UE Context Setup Request message that includes handover preparation information, and

receiving, by the processing hardware from the base station DU in response to the UE Context Setup Request message, a UE Context Setup Response message including the cell group configuration IE that includes the reconfiguration with synchronization IE.

Aspect 11. The method of aspect 9, wherein transmitting the indication to the base station DU includes: transmitting, by the processing hardware to the base station DU, a UE Context Setup Request message that includes cell group configuration information, and receiving, by the processing hardware from the base station DU in response to the UE Context Setup Request message, a UE Context Setup Response message including a cell group configuration IE that includes the reconfiguration with synchronization IE.

Aspect 12. The method of aspect 9, further comprising: receiving, by the processing hardware from a master base station, a request to add the base station CU and the base station DU as a secondary base station, the request including cell group configuration information from the master base station; and wherein transmitting the indication to the base station DU includes: transmitting, by the processing hardware to the base station DU, a UE Context Setup Request message that includes the cell group configuration information from the master base station, and receiving, by the processing hardware from the base station DU in response to the UE Context Setup Request message, a UE Context Setup Response message including the cell group configuration IE that includes the reconfiguration with synchronization IE.

Aspect 13. The method of aspect 9, wherein the base station CU and the base station DU operate as an SN, and wherein the indication transmitted to the base station DU is received from an MN.

Aspect 14. The method of aspect 13, wherein the indication from the MN is a CG-ConfigInfo IE.

Aspect 15. The method of aspect 9, further comprising: receiving, by the processing hardware from the base station DU, a radio resource control (RRC) request for one of (i) setting up a new RRC connection, (ii) resuming an RRC connection, or (iii) reestablishing an RRC connection, transmitted by the UE; wherein transmitting the message includes generating an RRC command responsive to the request from the UE.

Aspect 16. A base station CU comprising processing hardware configured to implement a method of any of the preceding aspects.

Aspect 17. A method in a base station DU coupled to a base station CU, the method comprising: receiving, by processing hardware from a base station CU, an indication that a UE should perform a reconfiguration with sync procedure; generating, by the processing hardware, a cell group configuration IE that includes a reconfiguration with synchronization IE, for the UE; transmitting, by the processing hardware to the base station CU, the cell group configuration IE; receiving, by the processing hardware from the base station CU, a message for the UE including the cell group configuration IE; and transmitting, by the processing hardware to the UE, the message.

Aspect 18. The method of aspect 17, further comprising: receiving, by processing hardware from the UE, an RRC request for one of (i) setting up a new RRC connection, (ii) resuming an RRC connection, or (iii) reestablishing an RRC connection, transmitted by the UE; wherein message received from the base station CU is an RRC command responsive to the RRC request from the UE.

Aspect 19. The method of aspect 17, wherein: the indication is received in a UE Context Setup Request message, and the cell group configuration IE is transmitted in a UE Context Setup Response message.

Aspect 20. The method of aspect 18, further comprising: determining that the indication has been received if the UE Context Setup Request message includes handover preparation information.

Aspect 21. The method of aspect 18, further comprising: determining that the indication has been received if the UE Context Setup Request message includes a cell group configuration IE or a CG-ConfigInfo IE.

Aspect 22. The method of aspect 17, further comprising: transmitting, by the processing hardware to the base station CU, an IE presence indicator indicating that the cell group configuration IE includes a reconfiguration with synchronization IE.

Aspect 23. The method of aspect 17, further comprising: transmitting, by the processing hardware to the base station CU, an IE absence indicator indicating that the cell group configuration IE does not include the reconfiguration with synchronization indication IE.

Aspect 24. The method of aspect 22 or 23, further comprising transmitting the IE presence indicator or the IE absence indicator in one of an Initial UL RRC Message Transfer message or a UE Context Setup Response message.

Aspect 25. A base station distributed unit (DU) comprising processing hardware configured to implement a method of any of aspects 17-24.

Aspect 26. A disaggregated base station comprising: a distributed unit (DU) and a central unit (CU) communicatively coupled to the base station DU; the disaggregated base station including processing hardware configured to: receive, via a radio interface from a user equipment (UE), an RRC message; determine that the UE should not perform a reconfiguration with sync procedure; and transmit an RRC command responsive to the RRC message, the RRC command including a cell group configuration IE and not including a reconfiguration with synchronization IE.

What is claimed is:

1. A method in a base station central unit (CU) coupled to one or more base station distributed units (DUs), the method comprising:
determining, by processing hardware, that a UE should perform a reconfiguration with sync procedure;
transmitting, by the processing hardware to a base station DU, an indication that the UE should perform a reconfiguration with sync procedure;
receiving, by the processing hardware in response to the indication, a cell group configuration IE including a reconfiguration with synchronization IE; and
transmitting, by the processing hardware to the base station DU, a message including the cell group configuration IE, to be forwarded to the UE.

2. The method of claim 1, wherein the transmitting the indication to the base station DU includes:
transmitting, by the processing hardware to the base station DU, a UE Context Setup Request message that includes handover preparation information, and
wherein the receiving the cell group configuration IE including the reconfiguration with synchronization IE is in response to the UE Context Setup Request message and included in a UE Context Setup Response message.

3. The method of claim 1, wherein transmitting the indication to the base station DU includes:
transmitting, by the processing hardware to the base station DU, a UE Context Setup Request message that includes cell group configuration information, and
wherein the receiving the cell group configuration IE including the reconfiguration with synchronization IE is in response to the UE Context Setup Request message and included in a UE Context Setup Response message.

4. The method of claim 3, wherein transmitting the UE Context Setup Request message is in response to determining that at least one DRB is set up for the UE.

5. The method of claim 1, further comprising:
receiving, by the processing hardware from a master base station, a request to add the base station CU and the base station DU as a secondary base station, the request including cell group configuration information from the master base station;
and wherein transmitting the indication to the base station DU includes:
transmitting, by the processing hardware to the base station DU, a UE Context Setup Request message that includes the cell group configuration information from the master base station, and
wherein the receiving the cell group configuration IE including the reconfiguration with synchronization IE is in response to the UE Context Setup Request message and included in a UE Context Setup Response message.

6. The method of claim 1, wherein the base station CU and the base station DU operate as a secondary node (SN) to support dual connectivity (DC) at the UE.

7. The method of claim 6, further comprising receiving the indication from a master node (MN), prior to transmitting the indication to the base station DU.

8. The method of claim 1, wherein the indication is a CG-ConfigInfo IE.

9. The method of claim 1, including transmitting the indication in a CU to DU RRC Information IE.

10. The method of claim 1, further comprising:
receiving, by the processing hardware from the base station DU, a radio resource control (RRC) request for one of (i) setting up a new RRC connection, (ii) resuming an RRC connection, or (iii) reestablishing an RRC connection, transmitted by the UE;
wherein transmitting the message includes generating an RRC command responsive to the request from the UE.

11. The method of claim 1, further comprising:
receiving, by the processing hardware from the base station DU, an Initial UL RRC Message Transfer message including the cell group configuration IE that does not include the reconfiguration with synchronization indication IE.

12. A method in a base station distributed unit (DU) coupled to a base station central unit (CU), the method comprising:
receiving, by processing hardware from a base station CU, an indication that a UE should perform a reconfiguration with sync procedure;
generating, by the processing hardware, a cell group configuration IE that includes a reconfiguration with synchronization IE, for the UE;
transmitting, by the processing hardware to the base station CU, the cell group configuration IE;
receiving, by the processing hardware from the base station CU, a message for the UE including the cell group configuration IE; and
transmitting, by the processing hardware to the UE, the message.

13. The method of claim 12, further comprising:
receiving, by processing hardware from the UE, an RRC request for one of (i) setting up a new RRC connection, (ii) resuming an RRC connection, or (iii) reestablishing an RRC connection, transmitted by the UE;
wherein the message received from the base station CU is an RRC command responsive to the RRC request from the UE.

14. The method of claim 12, wherein:
the indication is received in a UE Context Setup Request message, and
the cell group configuration IE is transmitted in a UE Context Setup Response message.

15. The method of claim 12, further comprising:
determining that the indication has been received if the UE Context Setup Request message includes handover preparation information.

16. The method of claim 12, further comprising:
determining that the indication has been received if the UE Context Setup Request message includes a cell group configuration IE or a CG-ConfigInfo IE.

17. The method of claim 12, further comprising:
transmitting, by the processing hardware to the base station CU, an Initial UL RRC Message Transfer message including the cell group configuration IE that does not include the reconfiguration with synchronization indication IE.

18. A base station central unit (CU) coupled to one or more base station distributed units (DUs), the base station CU comprising processing hardware and configured to:
determine that a UE should perform a reconfiguration with sync procedure;
transmit, by to a base station DU, an indication that the UE should perform a reconfiguration with sync procedure;
receive, by in response to the indication, a cell group configuration IE including a reconfiguration with synchronization IE; and
transmit, by to the base station DU, a message including the cell group configuration IE, to be forwarded to the UE.
